(19) United States
(12) Patent Application Publication
(10) Pub. No.: US 2011/0209192 A1
(43) Pub. Date: Aug. 25, 2011

(54) BIOMETRIC SOCIAL NETWORKING

(76) Inventors: Katelyn M. LeClerc Greer, South Burlington, VT (US); Peter C. Matthes, Belmont, MA (US); Vincent F. Cannistraro, Lincoln, MA (US)

(21) Appl. No.: 12/891,890

(22) Filed: Sep. 28, 2010

Related U.S. Application Data
(60) Provisional application No. 61/307,900, filed on Feb. 25, 2010.

(51) Int. Cl. G06F 21/00

(52) U.S. Cl. 726/1

(57) ABSTRACT

A method for maintaining a social network includes registering users in the social network, wherein registering users includes storing in association with a user ID for each registered user at least one image and verifying the user during a subsequent login by comparing a current image with the stored image. User interactions within the social networking system are restricted by a third party.

### CROSS-REFERENCE TO RELATED APPLICATIONS

This application claims the benefit of U.S. provisional application No. 61/307,900 filed on Feb. 25, 2010, which is hereby incorporated by reference in its entirety.

### BACKGROUND

1. Field

This invention relates to social networking systems and more specifically to a social networking system for children.

2. Description of the Related Art

Social networking systems generally focus on building social networks and reflecting social relations among people, e.g., who share interests and/or activities. Social networking systems are a means to connect with friends, such as former school-year classmates, and the like. A social networking system may generally include a profile of a user, their social links, and a variety of additional services. Most social networking systems provide means for users to interact over the Internet, such as e-mail and instant messaging.

Further, social networking systems may allow users to share ideas, activities, events, and interests within their individual networks. Further, social networking may not only be limited to adults. Social networking systems, especially for kids, children, teenagers, and the like, are popular today. However, there have been concerns about misuse of these social networking systems by children, teenagers, and adults. The safety of children on social networking systems is a matter of concern for parents, the authenticity of identity of a user being one of the major concerns.

Therefore, there is a need for a social networking system that provides authentic information about the identity of a user as well as limits the possible range of interactions.

### SUMMARY

A social networking system may include a networked computer for presenting the social networking system to a user and a biometric access device connected to the networked computer for enabling a user to access the social networking system. The biometric access device may be at least one of a fingerprint scanner, a retinal scanner, a bone density scanner, and a facial recognition scanner. Restrictions on user interactions within the social networking system may be set by a third party. Further, the third party may include at least one of parents, a guardian, a teacher, and a mentor.

In an aspect of the invention, a method for maintaining a social networking system is provided. The method may include registering users in the social networking system. Registration of users may include storing an image of a user in association with a user ID for each registered user. Further, the method may include verifying the user during a subsequent login by comparing a current image with the stored image.

In another aspect of the invention, a method for setting a group in a social networking system is provided. The method may include determining a threshold for interaction. Further, the method may include determining if the range meets a threshold.

In yet another aspect of the invention, a method for setting a group in a social networking system is provided. The method may include determining a threshold for interaction. The method may further include enabling a user to interact with others of the peer range group. In addition, the method may include blocking users from interacting with others not in the peer group.

In another aspect of the present invention, a method for moderating wall posts in a social networking system is provided. The method may include receiving notification of a wall post. Further, the method may include reviewing the wall post. The method may also include moderating the wall post. In case, the wall post is approved, the wall post may be enabled to publish to the wall. However, if the wall post is not approved, the wall post may be blocked from publishing to the wall.

In still another aspect of the present invention, a method for a collaborative project is provided. The method may include initiating a group project on a social networking system. The method may further include enabling a first user to participate in the group project. Furthermore, the method may include updating the project with a first user's changes. In addition, the method may include notifying users of the project update. Also, the method may include enabling one or more additional users to participate in the updated project.

These and other systems, methods, objects, features, and advantages of the present invention will be apparent to those skilled in the art from the following detailed description of the preferred embodiment and the drawings.

All documents mentioned herein are hereby incorporated in their entirety by reference. References to items in the singular should be understood to include items in the plural, and vice versa, unless explicitly stated otherwise or clear from the text. Grammatical conjunctions are intended to express any and all disjunctive and conjunctive combinations of conjoined clauses, sentences, words, and the like, unless otherwise stated or clear from the context.

### BRIEF DESCRIPTION OF THE FIGURES

The invention and the detailed descriptions of certain embodiments thereof may be understood by reference to the following figures:

FIG. 1 depicts components of a system facilitating social interactions among users, in accordance with an embodiment of the present invention;

FIG. 2 is a flowchart depicting a method for maintaining a social network, in accordance with an embodiment of the present invention;

FIG. 3 depicts exemplary groups that a user may join, in accordance with an embodiment of the present invention;

FIG. 4 is a flowchart depicting a method for setting a group, in accordance with an embodiment of the present invention;

FIG. 5 is a flowchart depicting another method for setting a group, in accordance with another embodiment of the present invention;

FIG. 6 depicts an option for uploading photographs, in accordance with an embodiment of the present invention;

FIG. 7a depicts a resource center for third-party users, in accordance with another embodiment of the present invention;

FIG. 7b depicts an exemplary view of the resource center for third-party users, in accordance with another embodiment of the present invention;

FIG. 8 depicts an exemplary view of general information provided to third-party users, in accordance with an embodiment of the present invention;

FIG. 9 depicts another exemplary view of the general information for third-party users, in accordance with the embodiment of the present invention;

FIG. 10a depicts an exemplary view of profile of a user, in accordance with an embodiment of the present invention;

FIG. 10b depicts another exemplary view of the profile of the user, in accordance with the embodiment of the present invention;

FIG. 11 depicts a customization option available to a user, in accordance with an embodiment of the present invention;

FIG. 12 is a flowchart depicting a method for moderating wall posts in a social networking system, in accordance with an embodiment of the present invention;

FIG. 13 is a flowchart depicting a method for a collaborative project, in accordance with an embodiment of the present invention;

FIG. 14 depicts a view of a comments page, in accordance with an embodiment of the present invention;

FIG. 15 depicts an exemplary view of an inbox of a user, in accordance with an embodiment of the present invention;

FIG. 16a depicts an exemplary view of an update webpage, in accordance with an embodiment of the present invention;

FIG. 16b depicts another exemplary view of the update webpage, in accordance with the embodiment of the present invention;

FIG. 17a depicts an exemplary view of a friend's profile, in accordance with an embodiment of the present invention;

FIG. 17b depicts another exemplary view of the friend's profile, in accordance with the embodiment of the present invention; and

FIG. 18 depicts an exemplary view of games provided by the social networking system, in accordance with an embodiment of the present invention.

### DETAILED DESCRIPTION

The present invention provides a social networking system for children, who may connect and interact with their real-life friends and family in a safe, child-friendly place.

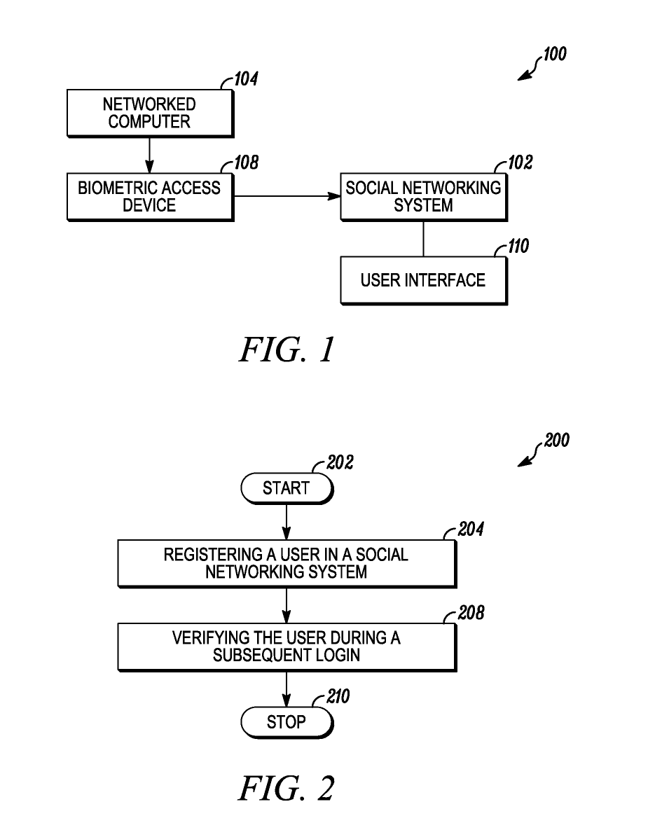

FIG. 1 depicts components of a system 100 facilitating social interactions among users, in accordance with an embodiment of the present invention. In an example, the users may include children or kids and teenagers. In examples, interactions may include exchange of creative ideas, social networking, educational discussions, games, and the like. The system 100 may also provide user-defined and secure interactions and may allow a third party to modify settings for the interactions. Further, the various components of the system 100 may include a social networking system 102, a networked computer 104, a biometric access device 108, and a user interface 110. In an embodiment of the invention, the social networking system 102 may provide an experience similar to the experience of an adult social networking website; however, it may be age-appropriate and parent-monitored.

In an embodiment of the invention, the social networking system 102 may be accessed by a user via the networked computer 104 coupled to the biometric access device 108. In examples, the social networking system 102 may be, without limitation, a website, a web page, or a software application. Further, the networked computer 104 may provide secure access to the user using the biometric access device 108. In various embodiments of the invention, the biometric access device 108 may include, without limitation, a fingerprint scanner, a retinal scanner, a bone density scanner, and a facial recognition scanner. The social networking system 102 may also have a non-secure landing page that may describe the features of the social networking system 102, may provide information on how to gain access to the social networking system 102, and other information related to the social networking system 102. The social networking system 102 may also provide the user interface 110, which may be used by the user to interact with other users. In an embodiment of the invention, before a user may initiate interaction with other users, the user may have to first register with the social networking system 102. Once the user registers with the social networking system 102, the user may maintain a social network.

FIG. 2 is a flowchart depicting a method 200 for maintaining a social network, in accordance with an embodiment of the present invention. The method 200 starts at step 202. At step 204, a user may register with the social network. In an embodiment of the invention, for registering in the social network, the user may need to provide three verified photographs. These verified photographs may get stored in the social networking system 102 along with a user ID. In an embodiment of the present invention, the user ID may be a name of the user, e-mail address of the user, a selected name, and the like. Further, the networked computer 104 may include a webcam that may be associated to the biometric access device 108. In an example, the webcam may be associated with the facial recognition scanner. Thereafter, at step 208, the user may be verified during a subsequent login into the social networking system 102. For verifying the user, the biometric access device 108 may compare the face of the user with the stored images to verify the user, before allowing them to log in to the social networking system 102. In an embodiment of the invention, the user may not be able to log into the social networking system 102 if the stored image of the user does not match with the image captured by the biometric access device 108. The social networking system 102 may then send a message to the user requesting submission of new photographs. In embodiments, the message may be sent to a parent of the user for submitting new photographs. Further, after matching the stored photographs with the face of the user, the biometric access device 108 may provide a value that defines a percentage of certainty of image match. Such a value may be compared to a level of confidence before providing access to the user to the social networking system 102. The level of confidence may be predefined by the parent, an administrator, a guardian, a teacher, and the like. Further, the social networking system 102 may allow a moderator to modify the level of confidence as per requirement. In examples, the moderator may be an administrator, a guardian, a teacher, the parent, and the like. For example, the skin tone of the user may change due to environmental factors and thus, the biometric access device 108 may not allow the user to log in to the system due to mismatch with the stored photographs. Therefore, the moderator may change the level of confidence to match the predefined level of confidence. Further, the moderator may also counteract the results of the biometric access device 108. Alternatively, in an embodiment of the invention, the user may need to provide a user ID and a password, in addition to the face recognition procedure. The method 200 terminates at 210.

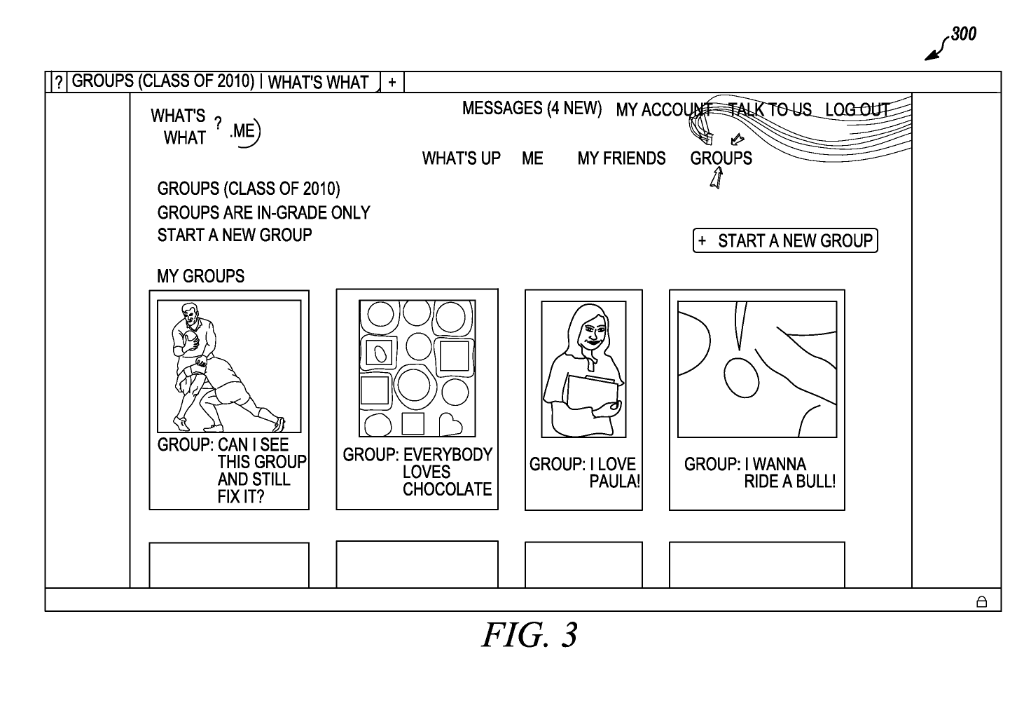

Further, in an embodiment of the invention, a user may be a part of a group and may interact with other users of the same group or of different groups. Referring to FIG. 3, which depicts the exemplary groups 300 that a user may join, in accordance with an embodiment of the present invention. Further, the social networking system 102 may allow the users to interact with limited groups, such as age range groups, grade groups, school groups, class groups, neighborhood groups, and the like. In an example, only children of the same grade such as class of 2010, and the like, may be allowed to interact with each other. Further, users of the same grade may create ‘in-grade groups’. Such ‘in-grade groups’ may be based on topics of users' interests such as games, eating habits, and the like. Examples of similar ‘in-grade groups’ may include groups such as ‘everybody loves chocolates’, ‘I wanna ride a bull’, and the like.

In an embodiment, the social networking system 102 may provide age group classification of users, such as age groups, specific ages, and the like. For example, only children within an age gap of two years would have the possibility to interact on the social networking system 102. In an embodiment, the social networking system 102 may provide geographic classification of users, such as by country, state, city, zip code, and the like. In an example, only users within a certain geographical distance would have the possibility to interact on the social networking system 102. In another example, only users within a certain spoken language group would have the possibility to interact on the social networking system 102. In yet another example, only users from the same school or school system would have the possibility to interact on the social networking system 102. Any of the limiting factors may be combined, for example, interactions may be limited to users of a certain age from a certain school. In an embodiment, a moderator, a parent, a website host, and the like, may set the above-described limitation ranges.

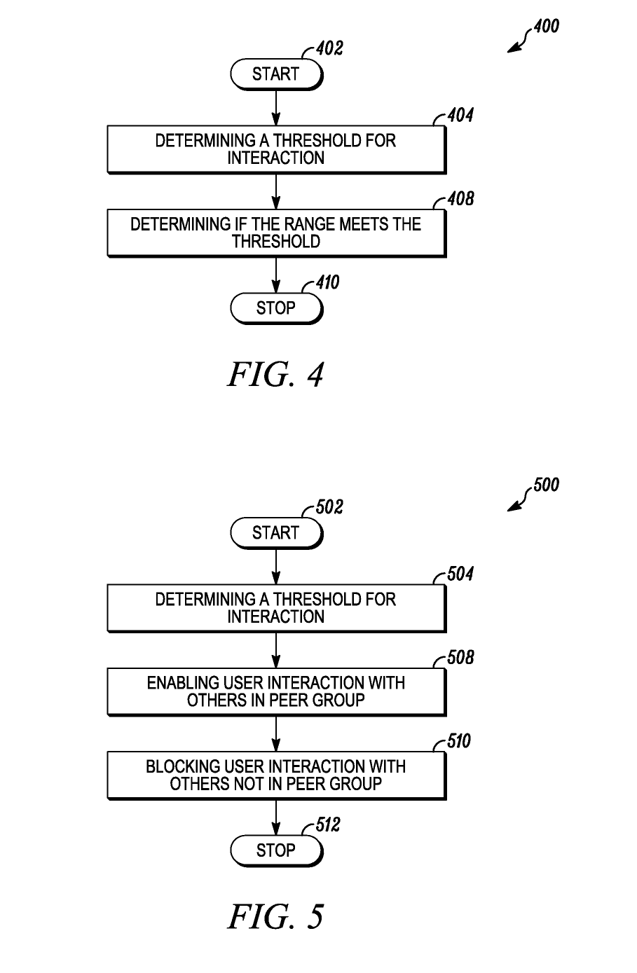

Referring to FIG. 4, a method 400 for setting a group is depicted in accordance with an embodiment of the present invention. The method 400 starts at 402. At step 404, a threshold for user interaction may be determined. In an example, the threshold may include a restriction on the number of the friends of the user with whom the user may interact. In another example, the threshold may be a +/−two year age gap. This threshold may be determined by the parents, teachers, mentors, and the like, of the user. At step 408, if a new contact wishes to be added into the contact list of the user, the demographics of the contact are compared with the threshold limit. If the contact falls within the threshold limit, the new contact may be added. If the contact exceeds the threshold limit, the new contact may be denied acceptance. In an embodiment, the threshold limit may be a number of contacts. If a user is only allowed to have 100 contacts, a new contact may be accepted or denied based on the total number of contacts that the user currently has. The method terminates at 410.

Further, referring to FIG. 5, a method 500 for setting a group is depicted in accordance with another embodiment of the present invention. The method starts at 502. At step 504, a threshold for user interaction may be determined. The threshold may be determined by the parents, teachers, mentors, and the like, of the user. Further, at step 508, the social networking system 102 may enable the user to interact with other users belonging to the same peer group. At step 510, interaction with other users, who may belong to different peer groups, may be blocked. In an embodiment, the user interaction may be blocked temporarily. For example, the parents of a user may modify the threshold for the peer range interaction of the user. The method terminates at 512.

In an embodiment of the invention, the social networking system 102 may provide a control panel or a moderator dashboard to the moderator that may allow the moderator to perform various functions. In an embodiment, the moderator dashboard may allow the moderator or parent to approve functions such as request from other users to be added as a friend. In another embodiment, the moderator may be provided with an override functionality. The override functionality of the moderator may enable the moderator to act against the results of the biometric access device 108. For example, the moderator may allow the user to log into the social networking system 102 even if the biometric access device 108 may not verify the user. In another embodiment, the moderator may disallow a user from logging in even though they provided a verified image through the biometric access device 108. In an embodiment, the moderator dashboard may allow the moderator to send and/or receive messages from the users such as kids, parents, teacher, and the like. In another embodiment, the moderator dashboard may enable the moderator to moderate photographs and other content that may be posted on the social networking system 102 by the users.

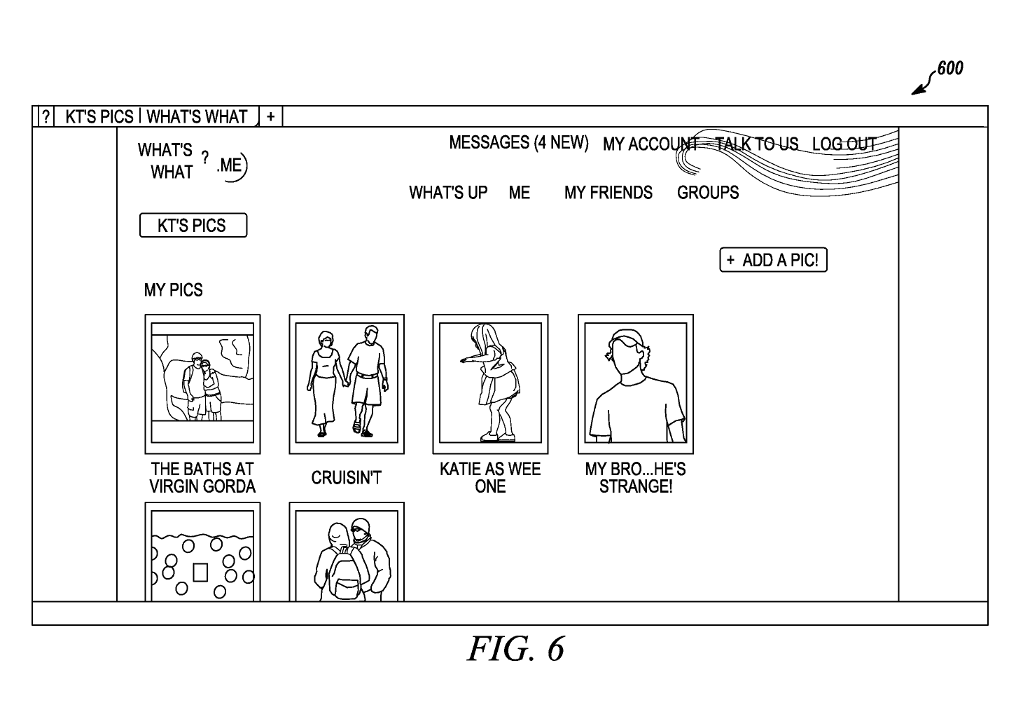

Further, referring to FIG. 6, social networking system 102 provides a facility 600 for uploading photographs, in accordance with an embodiment of the present invention. In an embodiment, the users may upload an absolute quantity of photographs to their accounts. For example, the absolute quantity may include uploading 10 photographs in a day and a maximum of 100. Likewise, the user may be prevented from frequently updating the photographs and contents that have been uploaded to the social networking system 102. In an embodiment of the invention, the frequency of updating a profile of the user may be restricted by the moderator.

Further, the dashboard may allow the moderator to moderate the content uploaded by users in real time. In an embodiment, the moderator may use the dashboard to set a tolerance level for automatically moderating predefined content that may be accessed by the users. For example, if a user accesses or uploads content related to violence such as guns, war, and the like, the moderator may automatically change such content to some other content in real time. In another embodiment, the moderator may prevent the user from accessing or uploading such content by flashing a message on a screen of the networked computer 104. For example, if a user tries to access videos that may contain some objectionable content, the moderator using the dashboard may automatically restrict the user from accessing the video content. In an exemplary embodiment of the present invention, the dashboard may allow the moderator to block such objectionable content so that users may not try to access them in future. The moderator dashboard may also enable the moderator to set and enforce restriction policies. For example, the moderator may put restriction on viewing certain websites, and the like. As described herein, the restriction may also include a time limitation, a geographical location restriction, an age restriction, and the like. In embodiment, the moderator may modify the restriction policy based on criteria such as grade of the user, age of the user, the results of a quiz, the parents'/guardians'/teachers' request and the like.

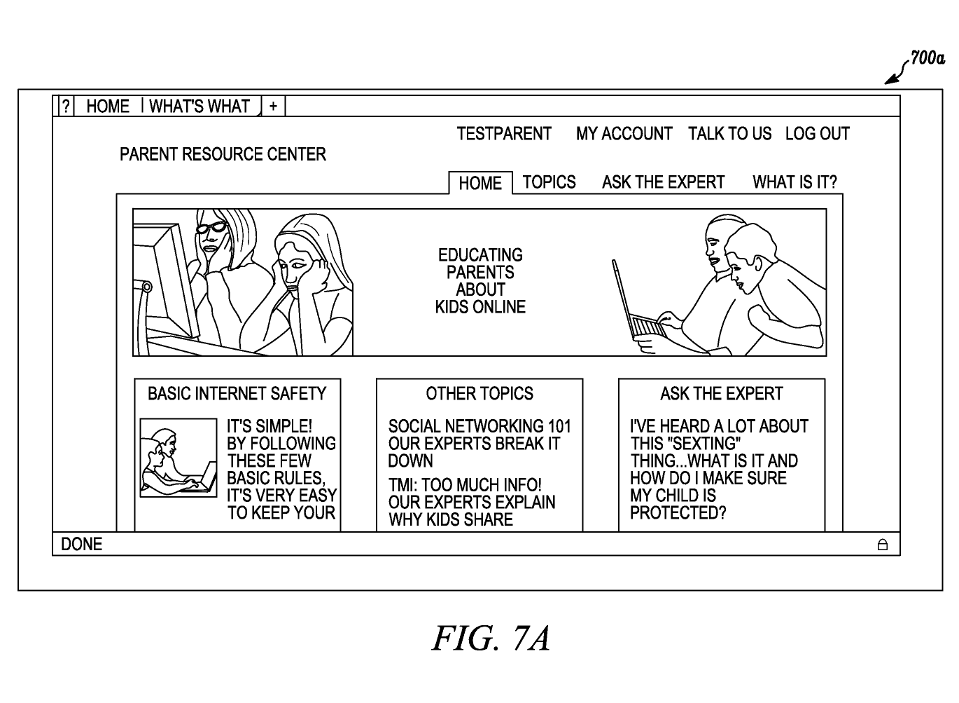

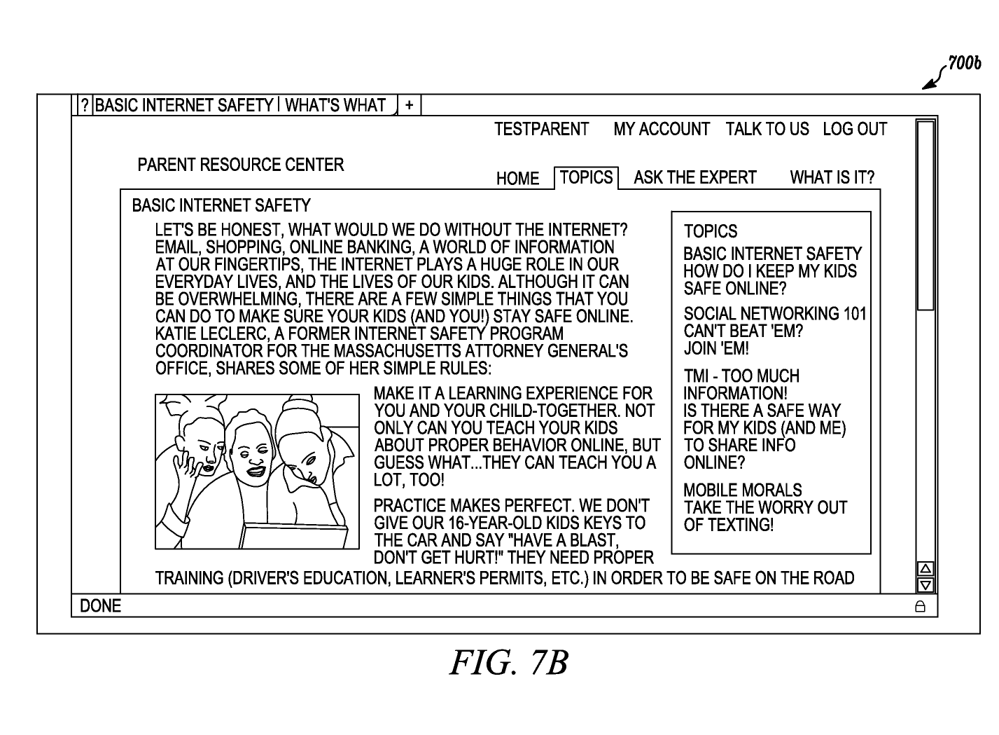

Referring to FIG. 7a, the social networking system 102 may provide a resource center 700 that may be accessed by a third party, in accordance with an embodiment of the invention. In an example, the third party may include a parent, a guardian, a teacher, a mentor, and the like. The resource center 700 may help in educating third-party users about various topics such as basic Internet safety, social networking, and the like. Further, the resource center 700 may enable third-party users to follow the online activities of users. The resource center 700 may enable the third-party users to customize a user's communication privileges. In an embodiment, the resource center 700 may allow third-party users to control accounts created by users. For example, third-party users such as parents may update the profiles of users, such as kids, teenagers, and the like. The parents may update the email address of the user or may change a profile picture used by the user. The resource center 700 may also provide administrative rights to third-party users. In embodiments, in order to change a user profile or add viewers to the profile, a third-party user may have to give permission to users. For example, the parent may grant permission to the user to chat with friends, accept content being shared by friends, and the like. Further, the parent may also withdraw permissions that may be already granted to the users. In an embodiment of the present invention, third-party users may communicate with experts through the resource center 700. The social networking system 102 may include contact details of experts such that parents, teachers, and the like may take help from experts regarding issues faced by users. Further, the resource center 700 may enable parents of a user to interact with parents of the user's friends. Such parent-to-parent interaction may allow parents to know more about the friends of their kids.

FIG. 7b depicts an exemplary view of the resource center 700, in accordance with an embodiment of the invention. As shown, the resource center 700 elaborates on the basic Internet safety topic. The resource center 700 educates third-party users about how to maintain safety of their kids, while the kids are online, and the like. The third party users may teach their kids about proper online behavior and may also learn new things at the same time.

In an embodiment of the present invention, the resource center 700 may facilitate third-party users to set contents of reports generated by the social networking system 102 as per their requirements. For example, third-party users may seek reports of various sites accessed by a user, the number of hours spent online, list of friends with whom the user interacted, and the like. The third party users may also access the reports on a daily basis, weekly basis, and the like. In another embodiment, third-party users may enquire about payment information and may modify payment options as per their convenience. The third-party users may require payment information such as charges, mode of payment, and the like, about some additional features that may be added to the social networking system 102.

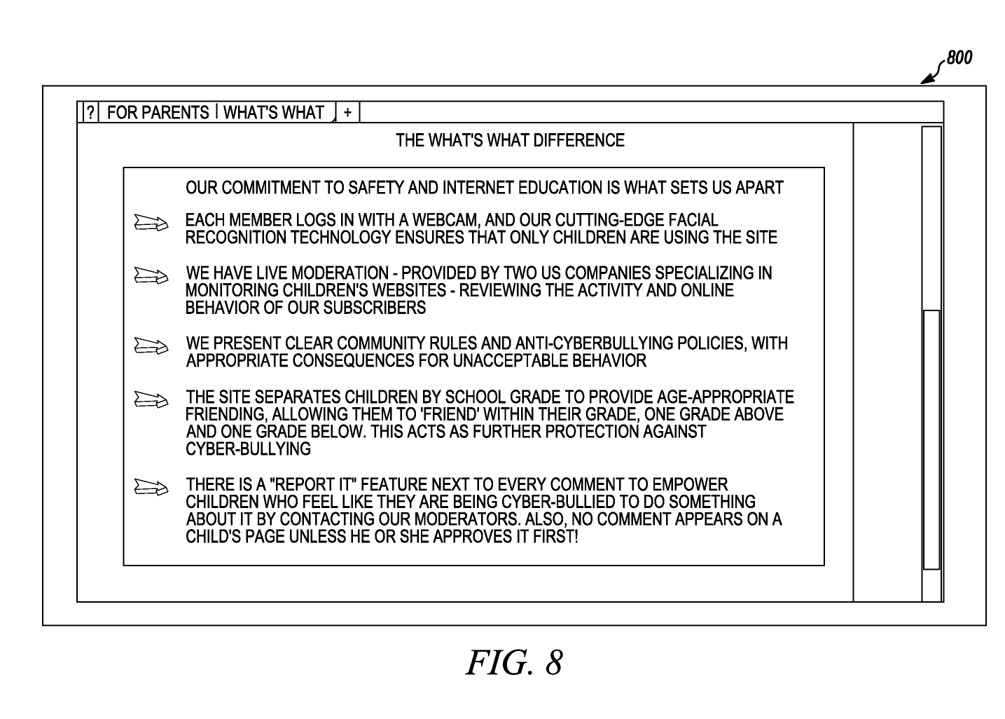

Referring to FIG. 8, an exemplary view 800 of general information provided to third-party users is depicted, in accordance with an embodiment of the present invention. The general information includes basic safety and Internet security information for enabling third-party users to understand the social networking system 102 in a better way. The view 800 briefly mentions various security measures that may be taken by the social networking system 102. The security measures may include information about biometric access device recognition when users try to log in. The live moderation facility that may enable to review the online activities and behavior of the users. Further, the security measures may include a reporting facility that may enable users to contact their moderators in case they encounter cyber bullying, and the like.

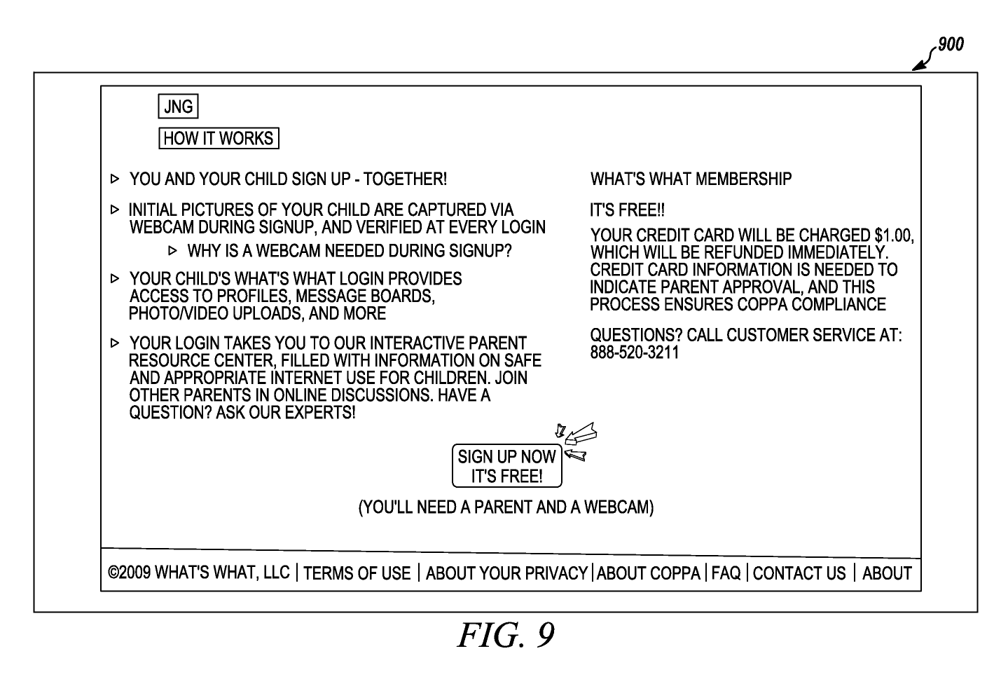

Now referring to FIG. 9, another exemplary view 900 of the general information for third-party users is depicted, in accordance with the embodiment of the present invention. The view 900 may include information about various features of the social networking system 102.

In the social networking system 102, the resource center 700 may allow a third-party user such as a parent, a guardian, a teacher, a mentor, and the like, to limit use of the social networking system 102 for users by setting one or more restrictions on use of the social networking system 102. Restrictions may include a time limitation, such as the total amount of time spent per time interval, time of the day restriction, certain hours in a day, and the like. For example, third-party users may restrict the user to access the social networking system 102 for a total of three hours in a day. In this example, the user may either use the social networking system 102 continuously for three hours or may divide the three hours as per convenience and/or requirement. In another example, the third party users may restrict the usage of the social networking system 102 by the user to a certain time of a day such as after school, in the evening, on weekends, and the like. In an embodiment, the user may be limited to interact with a given number of users in a given timeframe. For example, restricting interaction with a limited number of users in a given period of time such as in a day, in a week, and the like. Further, the third party user may limit the number of users that may interact with each other at the same time. In another embodiment, restrictions may include a geographical location restriction, such as restricting interaction with other users within a certain distance, a country, a state, a city, a zip code, a school, a school system, and the like. Restrictions may include age restrictions, such as restricting interactions with other users to those within a certain age range, of a specific age, and the like.

In embodiments, the administrative rights of third-party users may enable them to set a website of the social networking system 102 as the only website that may be accessible by the users. Other websites that may be required by the users may be delivered through a portal of the social networking system 102. In an embodiment, the social networking system 102 may be a portal. A third-party user may be able to grant access to the user only to the portal, through which the user may gain access to the rest of the Internet. Further, third-party users may be able to define the websites that users can access. The third-party users may then be able to set filters and restrictions through the portal. For example, the third-party users may set websites that may contain education content helpful for intellectual growth of the users.

In an embodiment, the resource center 700 may provide a report generating facility. The report generating facility may provide reports, including details regarding the amount of time a user may spend on a particular website. Further, the reports may also include the nature of usage of the website to the user. For example, the reports may indicate if the user is playing games through a website, reading educational articles, and the like. In an embodiment, the reports may also include details about other users with whom the user may be interacting. Such details may include names of the other users, age of the other users, location of the other users, total time of interaction, and the like. In an exemplary embodiment, the reports may also include details about various updates that may be provided by users regarding their status. It may be evident to a person skilled in the art that apart from the above-mentioned contents of the reports, the reports may also include other information such as the list of recently added contacts, contacts that have become inactive, content that has been blocked so far, and the like.

In an embodiment, the social networking system 102 may be able to email the third-party users and notify them whenever the user such as a kid, a teenager, and the like, may break a rule. For example, a third-party user may have set a time restriction for usage of the social networking system 102 by the user. If the user crosses that time restriction, the third-party user may be informed accordingly. In an embodiment, third-party users may also be notified if the user deletes comments sent to the user from other users. For example, if the user has uploaded some content such as a photograph on their profile, the user may receive comments from friends, teachers, parents, and the like. In case the user repeatedly deletes comments, the third-party user may be informed about it, as repeated deletion may be an indicator of cyberbullying.

In an embodiment, the social networking system 102 may collect statistics on users' interactions and use of the system. For example, if a user provides status updates, changes profile pictures, changes themes of the interface, and the like, which continually indicate he/she is in a bad mood, feels depressed, and the like, the system may report the statistics to a third party, such as the user's parent, teacher, or guardian. In another example, the system may generate a monthly report to the third party, such as a parent, detailing the amount of time the child spends on the system, the nature of use, children they are interacting with, information on status updates, and the like.

In embodiments, the third-party users may be notified about any bullying behavior shown by the user. For example, the user may be sending mean messages and e-mails, posting inappropriate pictures of others on the social networking system 102, and the like. In an example, other users may be repeatedly deleting the users' comments on their web page or photos. Timely notification of such behavior of the user may enable the third-party users to stop the user from bullying others. In another embodiment, the social networking system 102 may send email to third-party users and notify them whenever users add viewers to their page. In other embodiments, the social networking system 102 may send alerts via any communication method, such as an SMS, an MMS, an email, a voicemail, a website message, and the like.

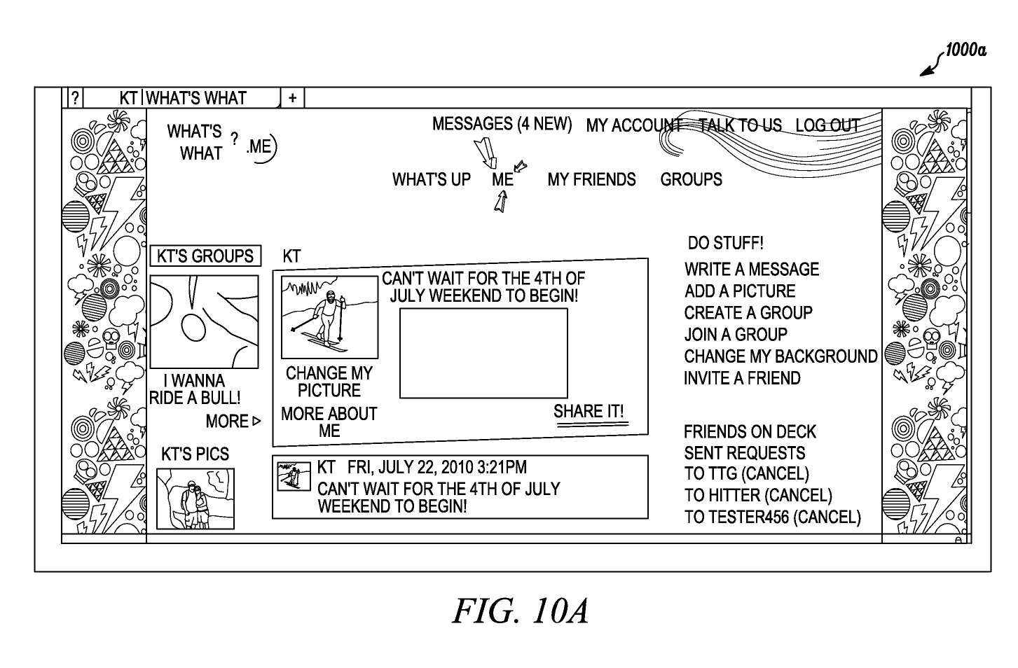

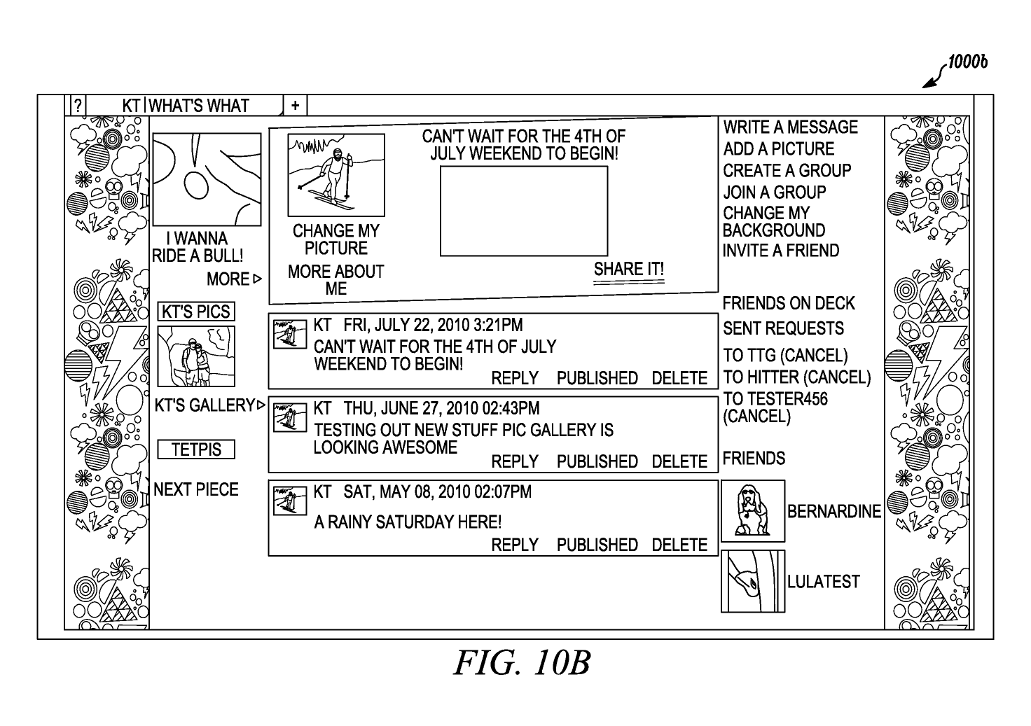

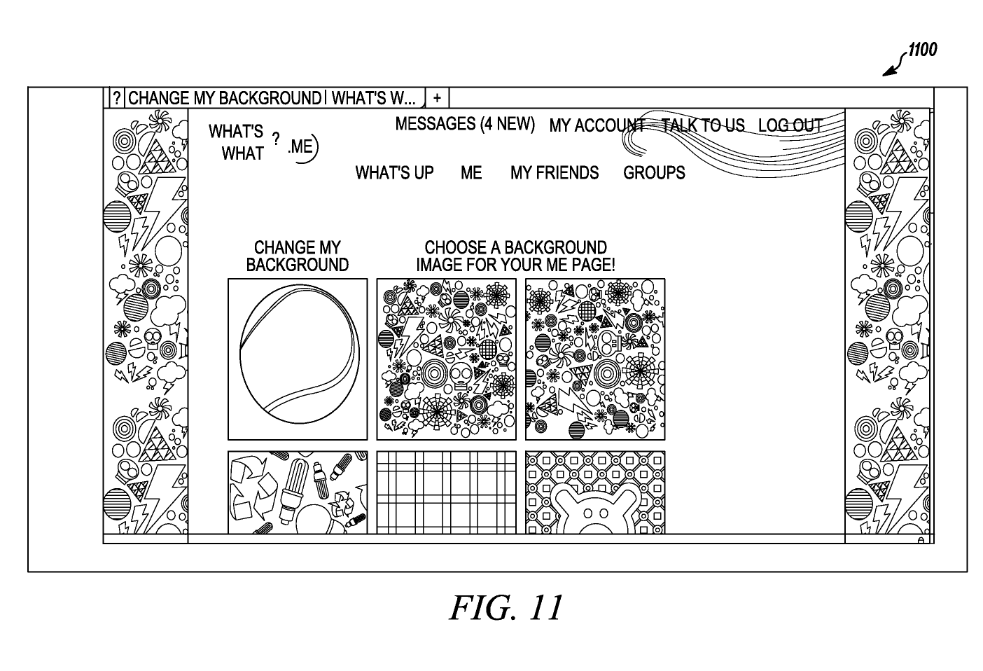

In an embodiment of the present invention, a user such as a kid, a child, a teenager, and the like may create their own profile in the social networking system 102. FIGS. 10a and 10b depict exemplary views 1000a and 1000b of a profile of a user, in accordance with an embodiment of the present invention. The user may be provided with options to enhance their profile. For example, the user may add a picture of their own, create a new group, join an already existing group, and the like. Further, the user may also track requests sent to other users for being added as a friend. The user may upload videos and pictures that may be viewed by other users who may visit the user's profile. As shown in FIG. 11b, the user may also find out friends that may be online at that time.

Referring to FIG. 11, a customization option 1100 available to a user is depicted in accordance with an embodiment of the present invention. The user may be able to customize various features of the social networking system 102. The social networking system 102 may include the user interface 110 for the user to access the social networking system 102. The user interface 110 may be a personal homepage. For example, a user may choose from a variety of borders, backgrounds, themes, graphics, pictures, music, video, and the like, to personalize their homepage. The users may customize the user interface as per their age, and the like. Users may be given step-by-step instructions on how to create their own personalization. In an embodiment, other users may view the various personalized aspects of the homepage; however, the homepage owner may set restrictions on what is publicly available, what is available to other confirmed users, what is available to a subset of confirmed users, and the like. A confirmed user may be a user or entity, such as a friend, schoolmate, family member, neighbor and the like, who requests to view the non-public portion of a user's homepage and engage in conversation with that user.

In embodiments of the present invention, the social networking system 102 may enable the user to moderate various messages that may be posted by friends, teachers, and the like, of the user. The user may moderate these messages by using a moderation tool that may be provided by the social networking system 102.

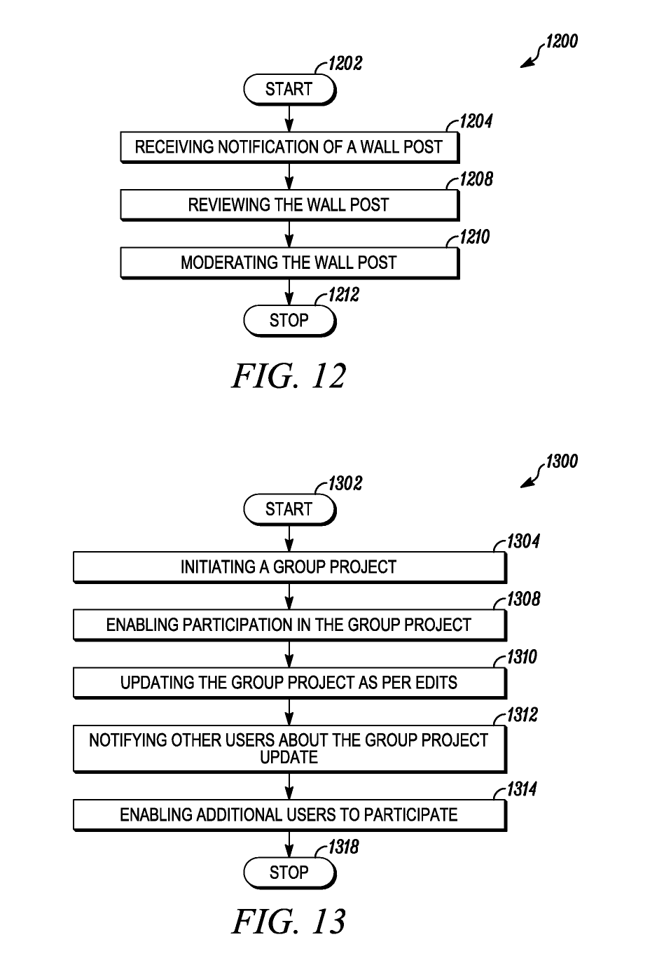

Referring to FIG. 12, a method 1200 for moderating wall posts in a social networking system is depicted, in accordance with an embodiment of the present invention. The method starts at 1202. At step 1204, a user may receive a notification about a wall post. At step 1208, the user may review the contents of the received wall post. Thereafter, at step 1210, the user may moderate the wall post. For example, if a post is made to the user's wall, it may be publically viewable by other contacts of the user or if comments relating to the user are made, the user may modify such posts or comments. In an exemplary embodiment, the user may delete such unsuitable posts or comments. In another embodiment, the user may report such posts or comments to an administrator, so that the user may avoid receiving such comments or posts in future. In an embodiment, the user may allow other contacts to view the posts or comments. Alternatively, the user may either hide such posts or comments or may allow only a subset of friends to view the posts or comments. In an embodiment, the moderations done by the user may be approved or rejected by the administrator. It may be evident to a person skilled in the art that the administrator may be a parent, a guardian, a teacher, and the like. For example, if the user may wish to delete a few posts on the profile wall, the user may need to have an approval from the administrator. If the administrator rejects the request from the user regarding any modification with respect to the posts or comments on the user's wall, the user may be unable to modify any content. The method 1200 terminates at 1212.

In another embodiment, the moderation tool may generate reports. The reports may include details about the profile information of the user's profile. For example, the reports may include information about friends that were added to the user's friends list, content that may be deleted by the user, and the like. In an embodiment, the reports may be generated daily, weekly, monthly, and the like. In an exemplary embodiment, the reports may be accessible by the administrator. In an embodiment of the present invention, the users may set privacy levels based on their requirements. The privacy level may refer to information related to the user that may be accessible to friends of the user. In an embodiment, the user may set a privacy level on a case-by-case basis. In one case, the user may associate a first contact with a privacy level 1 that may enable the first contact to access information only related to the user. In another case, the user may associate a second contact with a privacy level 2 that may allow the second contact to access updates and information related to the user and all contacts added in the user's profile. Further, the user may change the privacy levels associated with the contacts in the user's friends list.

In another embodiment, the user may set a privacy level in a blanket fashion. In other words, the user may set a particular privacy level to all the contacts that may come under a specific category such as contacts that may be of a same grade, same age, and the like. Accordingly, the user may set another privacy level to contacts that may not be directly known to the user and may have contacted the user through some common friends. Further, the user may blacklist or whitelist the contacts added into the profile of the user as per their past behavior. The users may blacklist confirmed or non-confirmed users so that they cannot view conversations with other users. For example, the user may blacklist a few contacts who may be trying to bully the user by sending messages, e-mails, and the like. In another example, the users may exclude their parents from viewing conversations. Similarly, the user may whitelist contacts as per the user's interaction with them.

In an embodiment, the social networking system 102 may also provide a user interface that may belong to/represent a group. Users may be provided with groups with whom users may share their interests. The users may join as many groups as they want. In another embodiment, users may form communities or youth organizations on the social networking system 102. Examples of the communities or youth organizations may include, but are not limited to, Girl Scouts, Boy Scouts, 4H, EF, City Year, Up With People, and US Youth Sports Organization. The communities or youth organizations may be categorized such as games, sports & recreation, jobs/career, religion & beliefs, schools & education, and the like. The social networking system 102 may be provided different interfaces for different communities or youth organizations. The users may relate to a particular community and may customize their profile as per the interface of that community. In an exemplary embodiment of the present invention, the user may be able to contact other users that may be following or a member of the same community as that of the user. In addition, the users may change skins of the interfaces as per their personal choice.

In embodiments of the present invention, the social networking system 102 may also include activities that may encourage users to collaborate with each other to perform those activities. Collaborative activities may prove vital for users as they may develop sustained shared thinking. For example, the social networking system 102 may include projects that may allow users to conduct scientific and mathematical investigations and then submit their collaborated data using an online form.

Referring to FIG. 13, a method 1300 for a collaborative project is depicted, in accordance with an embodiment of the present invention. The method 1300 starts at 1302. At step 1304, a group project may be initiated. The group project may be initiated by a teacher, a guardian, a parent, a mentor, a coach, and the like. Thereafter, at step 1308, the users may be informed about the initiation of the group project. In case, a user is interested in participating in the group project, the user may register into the group project. Further, the user may do some changes such as the user may add new data to the group project; edit the contents of the group project, and the like. At step 1310, the group project may be updated after the user has completed the changes in the group project. Thereafter, at step 1312, other users may be notified about the updated group project. Furthermore, the group project may be posted on the website of the social networking system 102. At step 1314, additional users may be enabled to participate in the group project. The method 1300 terminates at 1318.

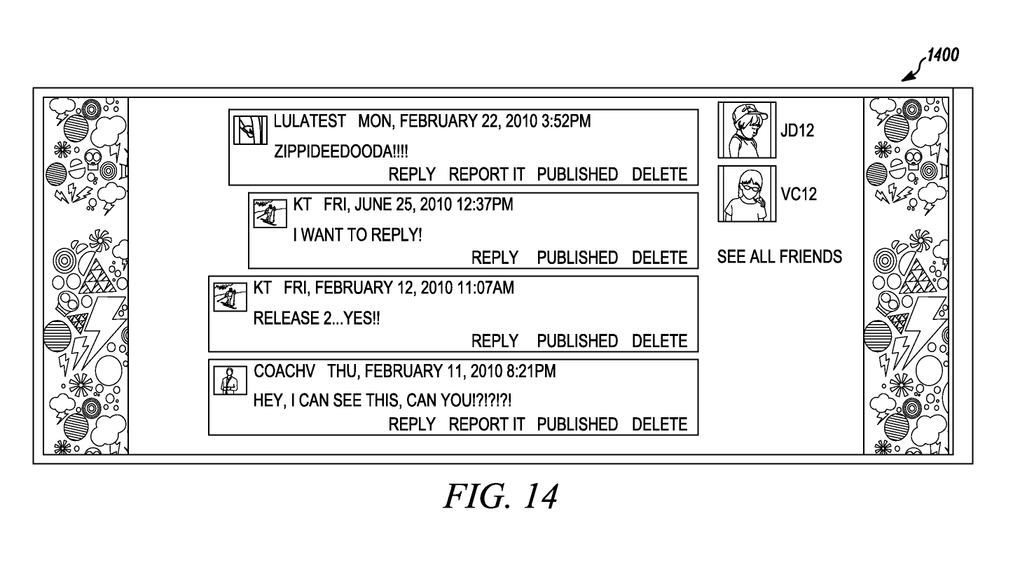

The collaborated data as mentioned above may be made available to other users who may post their comments about the project on participant users' walls. In an embodiment, the users may decide to work on a particular topic or may choose from a list of topics provided by the social networking system 102. As referred in FIG. 14, an exemplary view 1400 of comments is depicted, in accordance with an embodiment of the present invention. Visitors may leave their comments about the work done by the user either alone or in a group. Depending upon the contents of the comments, the user may modify the comments. The user may report about the comment in case the user feels offended by them, delete comments, publish the comments to be seen by everybody, and the like.

In an embodiment of the invention, the social networking system 102 may send notifications to the user based on the content of the user. In embodiments, the social networking system 102 may send alerts via a communication method, such as an SMS, an MMS, an email, a voicemail, a website message, and the like. For example, notification providing updates such as new comments on the wall, new friend requests, addition of new friends or removal of some contacts from the profile, and the like, may be sent to the user. In an exemplary embodiment, if users have added new content such as videos, pictures, and the like; to their profile, the contacts of users may be sent a notification. Further, the contacts may provide their comments about the new content. Also, the users may share the content from their profile with their friends. In another embodiment, notifications may be sent to parents, teachers, mentors, and the like, of the users, so that they may be updated about the content being used by the users.

In an embodiment of the invention, the social networking system 102 may prevent bulk messaging. The users may be precluded from sending messages to multiple contacts. In other words, the users may be encouraged to send messages through e-mails, blogs, and text messages to one contact at a time. The social networking system 102 may facilitate controlling cyber bullying by using such measures.

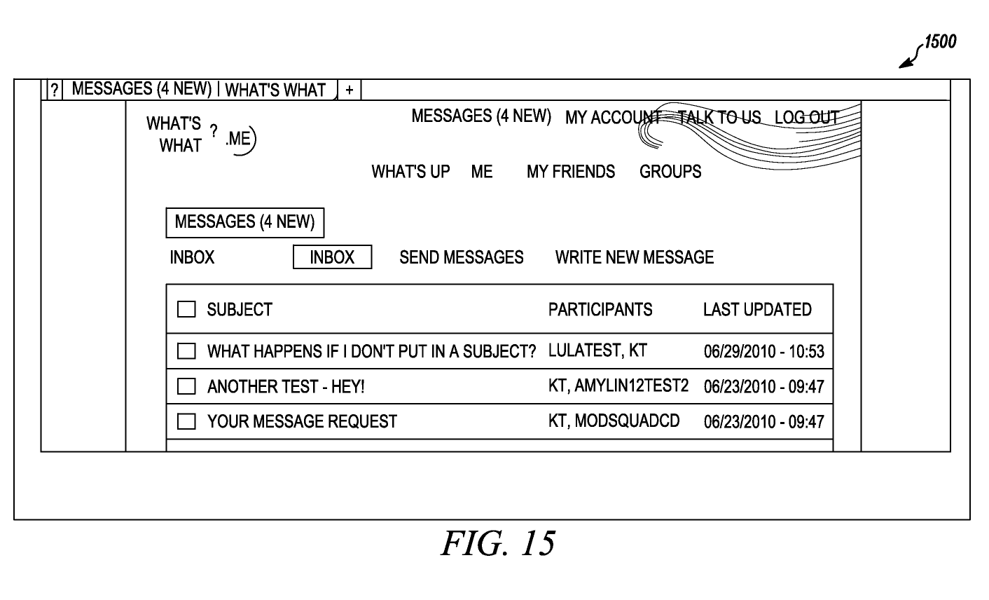

Referring to FIG. 15, an exemplary view 1500 of an inbox of a user is depicted, in accordance with an embodiment of the present invention. The user may be facilitated to send a private message to a contact that may be unavailable for other contacts to view.

In an embodiment, the social networking system 102 may enable teachers, mentors, coaches, and the like, to add content to the website of the social networking system 102. For example, if a teacher finds some content that may be of interest to a user, the teacher may add such content to the website of the social networking system 102. In another embodiment, the teacher may add a new website to the social networking system 102, so that the user may access it. Further, teachers may track the number of users who have visited a website added by them. The teachers may therefore encourage such users to share their knowledge or opinion about the website with other users.

In the social networking system 102, a user's ability to log into the social networking system 102, may be controlled by third-party users such as administrator, parents, teachers, Cub Scout group, and the like. In an embodiment, the users may be allowed to log into the social networking system 102 based on results of various tests conducted as part of their learning. The above-mentioned tests may be conducted by the administrator, the parents, the teachers, and the like. The tests may include questions that may vary as per the grade of the user, age of the user, and the like. For example, the parents of a kid may submit a test paper which they may want their kid to write. When the kid tries to log into the social networking system 102, the test paper will be provided to the kid. In case, the kid clears the test, the kid may be allowed to access the social networking system 102. Based on the results of the test, the kid may be rewarded. For example, the kid may be given extra access time by the parents, and the like. However, if the kid does not pass the test, access to the social networking system 102 may be denied. In an embodiment, the parents of a kid may decide a time period for which the kid may be denied access. For example, the kid may be denied access to the social networking system 102 until the kid clears the test. In another example, the kid may be denied access to the social networking system 102 for a few hours.

In an embodiment, a user may be able to perform a peer-based search on the social networking system 102. The user may wish to search for peers who may be using the social networking system 102, but may not be connected by the user. The user may carry out a search by providing information about peers. The information may include name, display name, e-mail address, geographic location, grade, school, and the like. It may be evident to a person skilled in the art that any of the information mentioned above may be combined; for example, the user may search for another kid by entering the name of the kid and locality where the kid resides.

In an embodiment, the social networking system 102 may be used as a mobile application. The mobile application may include a facial recognition scanner that may enable a user to login to the social networking system 102. The mobile application may provide some of the content to the user without performing facial recognition or any other biometric test. The biometric access to the system 102 can be overridden by a specific mobile device identifier, such as a specific cell phone number. In some embodiments, only certain features may be accessible via the mobile application. An administrator or moderator may set which features are available via mobile application. The mobile application may include other features enabled by the mobile platform, such as location-based services.

In an embodiment of the invention, the social networking system 102 may provide an instant messaging function for users to chat with each other. However, interaction among users may be restricted by a feature. The restrictions may be set up by the moderator. As mentioned herein, the moderator may be an administrator, a guardian, a teacher, the parent, and the like. The moderator may restrict the user to chat with selected users. For example, the moderator may restrict a user to interact with users of the same age group, same grade, same geographical location, and the like. In an embodiment, the restrictions may be combined; for example, the moderator may restrict the kid to chat with users of a particular age and belonging to a certain geographical location.

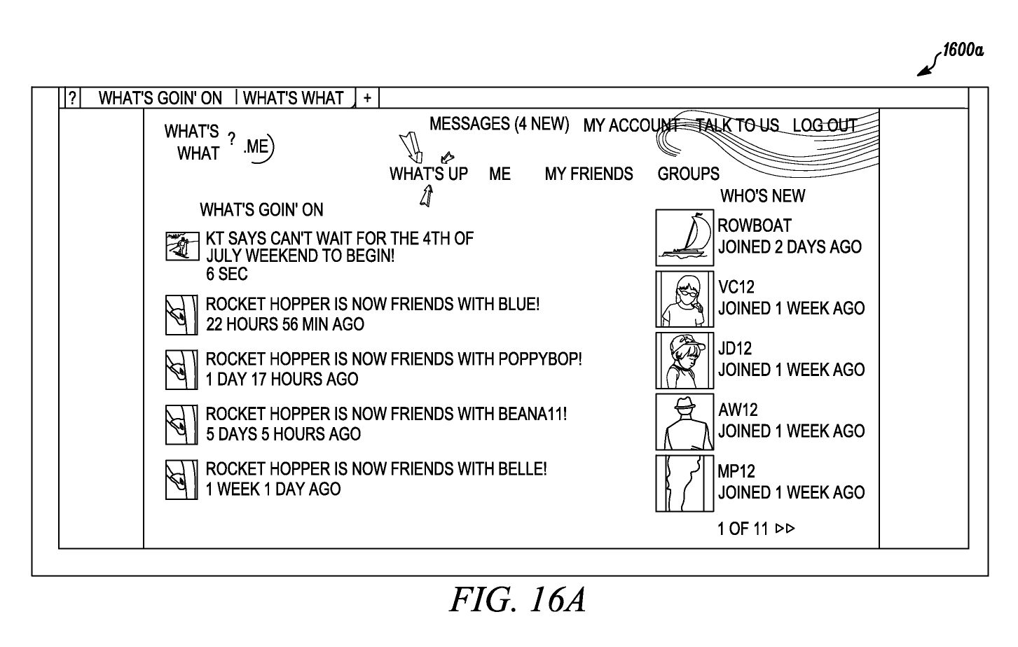

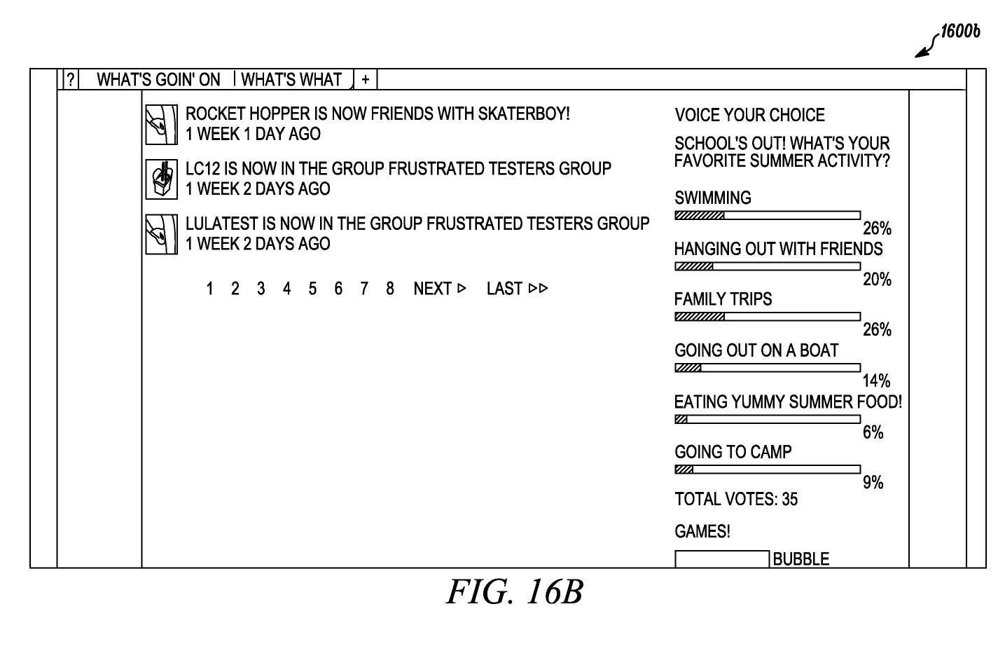

Now referring to FIG. 16a, an exemplary view 1600a of an update webpage is depicted, in accordance with an embodiment of the present invention. The update webpage may enable users to remain informed about the events happening in their neighborhood, among friends, and the like. Further, the update webpage may display content that may be unique to the users. In an embodiment, the update webpage may provide real-time updates on friends' daily activities. Further, the users may follow personal blogs and may send posts from one location. Additionally, the update webpage may include feeds of all activities taking place in their peer group. For example, the update webpage may include information about peer group members who may have added a new user as their friend. In another example, the update webpage may include information about any new content that has been uploaded by the peer group members.

Further referring to FIG. 16b, an exemplary view 1600b of the update webpage is depicted, in accordance with the embodiment of the present invention. The update webpage may include information about new users. Users may add a new user from their peer range based on seeing them on the update webpage. Further, users may post announcements of upcoming events such as concerts, parties, and the like. Furthermore, the users may remain updated about activities of their friends such as if any user has joined a new group, and the like.

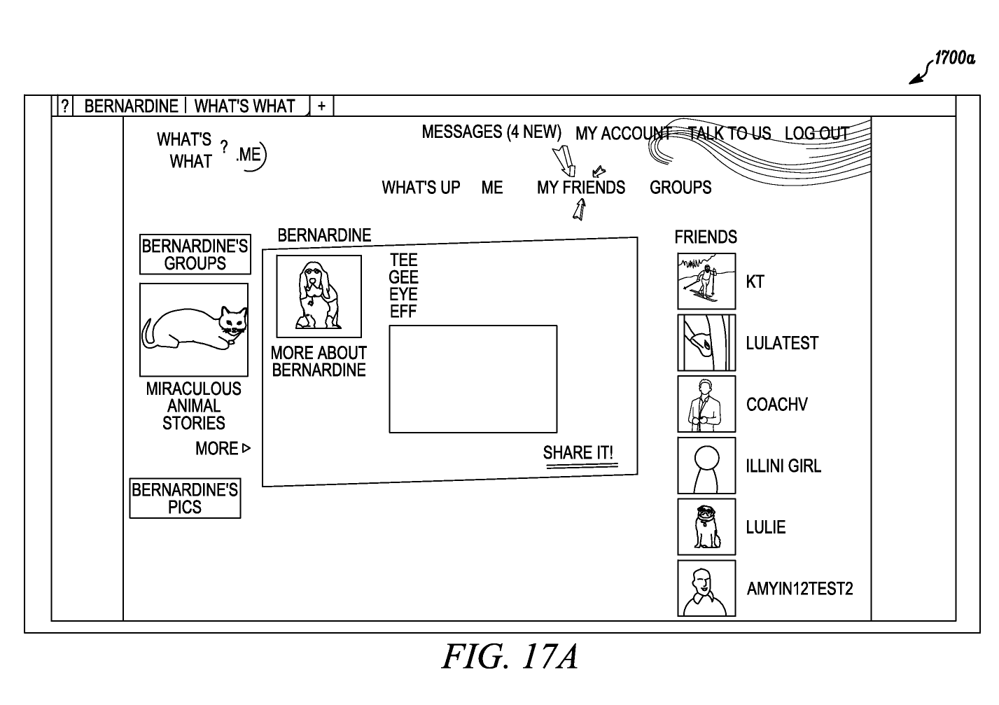

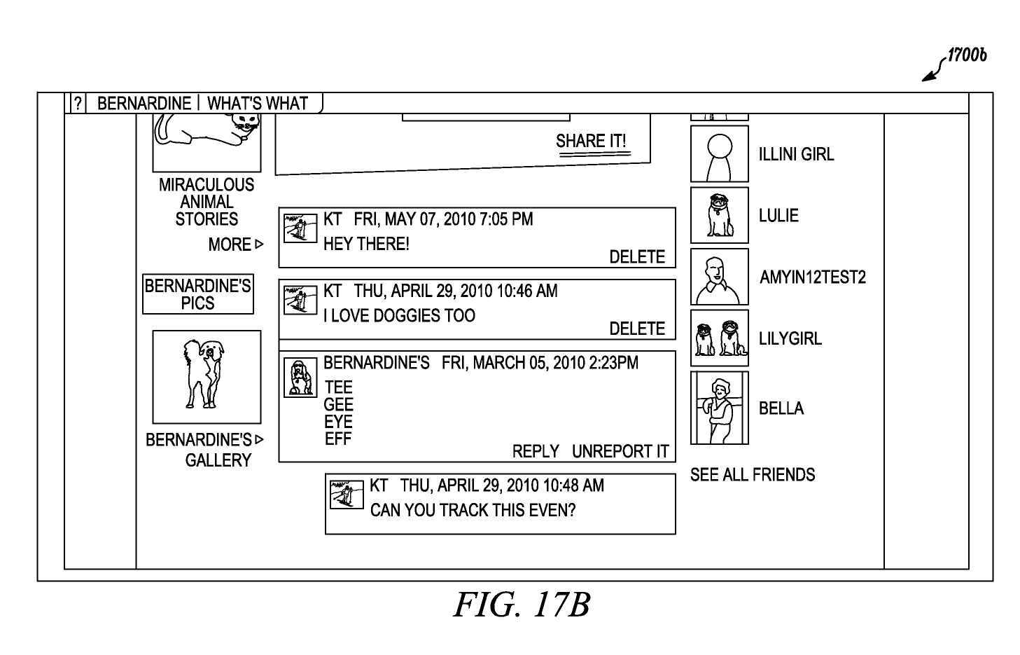

Now referring to FIG. 17a and FIG. 17b, exemplary views 1700a and 1700b of a friend's profile is depicted, in accordance with an embodiment of the present invention. A user may access a friend's profile and may view various groups that may be added to the friend's profile, contacts of the friend, content uploaded by the friend, comments received on the uploaded content, and the like. In another embodiment, the friend may publish the comments received on the uploaded content, so that visitors may see the comments. As shown in FIG. 17b, the comments that have not been published may be invisible to visitors and may only be seen by the friend and a sender of the comment.

In an embodiment of the invention, the social networking system 102 may enable sharing of content between friends. A user may be unable to share content with a new contact that may not be added as a friend by the user. For example, if a kid wants to share some videos with a new user, the kid may need to add the user as a friend and then the kid may share the videos.

In an embodiment of the invention, the social networking system 102 may include software that may filter out personally identifiable information from the username of a user. In case, if some information remains in the username, the software may prompt the user to change the username. In an embodiment, the personally identifiable information may include any kind of information that may indicate real name, geographical location, age, gender, race, and the like, of the user.

As described herein, the social networking system 102 may examine all the content that may be uploaded, shared, and viewed by the users. The social networking system 102 may also track public or private messages, such as e-mails, wall posts, blogs, and the like. If some content is found to include some objectionable matter, the social networking system 102 may replace such objectionable matter by replacement with a character.

In an embodiment, the social networking system 102 may enable users to interact with other users and/or the system in a defined and secure setting, modifiable by a third party. The interactions may include exchange of creative ideas, social networking, educational discussions, games, and the like. Users may be able to chat with users, send messages to users or other non-users, view updates from users, write on a user's homepage, interact with users they do not know, participate in surveys or groups with many users, some of which they may not know, and the like. Users may choose communications to be public or private. In an embodiment, users involved in a communication would have to agree to make their communication public and hence, it may be viewed/joined by others. In an embodiment, users may be able to identify other users based on a characteristic. For example, when users establish their homepage, they may fill in details of interests, demographic information, affiliations, alumni information, and the like. Users may identify each other by searching keywords related to the information on the homepage. Third parties may limit these sort of interactions along any of the lines described herein.

In an embodiment, the education interaction may comprise offerings of a particular style, such as Journal/Press Release Style, Tutoring/Lecture Style, “Gaming” Style, and the like. In the Journal/Press Release style, users may post information about current events, happenings, musings, and the like, on the site. In an embodiment, the post may go to the user's homepage, with links to more information, or may be posted to an aggregating site. The information may be user-generated content, system-generated content, or content pulled from an outside source, or a combination thereof. For example, a user may post a book review. Accompanying the book review, the user may post a poll. In the Tutoring/Lecture style, users may access various video presentations relative to the teaching of a certain subject. This may enable users to obtain more help at their own convenience, and at their own pace. The video presentations may be user-generated, system-generated, from a third party, and the like. For example, the user may be allowed to watch a video of some historic event, such as the launch of Apollo 13. In the video, the child's face, and/or voice may be used for a particular historic figure. In the Gaming style, the user may participate in various activities with a goal towards improving a certain aspect of the user's learning.

In an embodiment, the social networking system 102 may include interactive videos. The interactive videos may include video related to some historic event. In another embodiment, these interactive videos may be already provided within the social networking system 102 or may be provided by third-party users. In an embodiment of the invention, the content of the interactive videos may be approved by the administrator before allowing users to watch them. In use, users may be allowed to watch a video of a historic event. The users may be able to customize the appearances of historic figures appearing in the historical events. For example, users may replace the head of the historical figure with that of theirs. The users may also change the costume of the historical figure as per their choice and the like. In an exemplary embodiment, the users may wish to substitute voice of a historical figure with their voice.

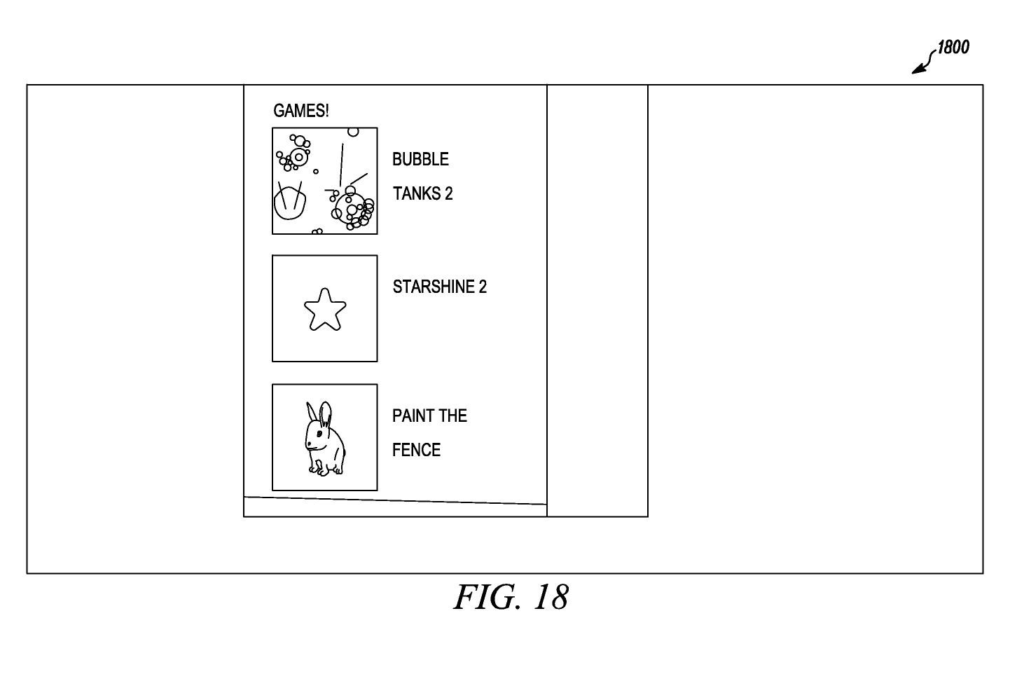

In an embodiment, the social networking system 102 may be used for gaming. Referring to FIG. 18, an exemplary view 1800 of games provided by the social networking system 102 is depicted, in accordance with an embodiment of the present invention. The social networking system 102 may enable the user to replace the head of an action figure with the user's head. In another embodiment, the social networking system 102 may include games that may be customizable with the user's face, artwork, voice, appearance choices, and the like. These games may be played solo or with one or more users. Further, the games may be provided within the system or may be provided by a third-party user.

In an embodiment, the structure of the social networking system 102 may be that of a house with different rooms. For example, each user's homepage may be his/her bedroom. The TV room may be the place to post or obtain current events. The study may be for educational interactions. The backyard may be for gaming. The house may have other rooms based on interests, age, affiliations, school, location, and the like, where users may meet others users.

The methods and systems described herein may be deployed in part or in whole through a machine that executes computer software, program codes, and/or instructions on a processor. The processor may be part of a server, client, network infrastructure, mobile computing platform, stationary computing platform, or other computing platform. A processor may be any kind of computational or processing device capable of executing program instructions, codes, binary instructions and the like. The processor may be or include a signal processor, digital processor, embedded processor, microprocessor or any variant such as a co-processor (math co-processor, graphic co-processor, communication co-processor and the like) and the like that may directly or indirectly facilitate execution of program code or program instructions stored thereon. In addition, the processor may enable execution of multiple programs, threads, and codes. The threads may be executed simultaneously to enhance the performance of the processor and to facilitate simultaneous operations of the application. By way of implementation, methods, program codes, program instructions and the like described herein may be implemented in one or more thread. The thread may spawn other threads that may have assigned priorities associated with them; the processor may execute these threads based on priority or any other order based on instructions provided in the program code. The processor may include memory that stores methods, codes, instructions and programs as described herein and elsewhere. The processor may access a storage medium through an interface that may store methods, codes, and instructions as described herein and elsewhere. The storage medium associated with the processor for storing methods, programs, codes, program instructions or other type of instructions capable of being executed by the computing or processing device may include but may not be limited to one or more of a CD-ROM, DVD, memory, hard disk, flash drive, RAM, ROM, cache and the like.

A processor may include one or more cores that may enhance speed and performance of a multiprocessor. In embodiments, the process may be a dual core processor, quad core processors, other chip-level multiprocessor and the like that combine two or more independent cores (called a die).

The methods and systems described herein may be deployed in part or in whole through a machine that executes computer software on a server, client, firewall, gateway, hub, router, or other such computer and/or networking hardware. The software program may be associated with a server that may include a file server, print server, domain server, internet server, intranet server and other variants such as secondary server, host server, distributed server and the like. The server may include one or more of memories, processors, computer readable media, storage media, ports (physical and virtual), communication devices, and interfaces capable of accessing other servers, clients, machines, and devices through a wired or a wireless medium, and the like. The methods, programs or codes as described herein and elsewhere may be executed by the server. In addition, other devices required for execution of methods as described in this application may be considered as a part of the infrastructure associated with the server.

The server may provide an interface to other devices including, without limitation, clients, other servers, printers, database servers, print servers, file servers, communication servers, distributed servers and the like. Additionally, this coupling and/or connection may facilitate remote execution of program across the network. The networking of some or all of these devices may facilitate parallel processing of a program or method at one or more location without deviating from the scope of the invention. In addition, any of the devices attached to the server through an interface may include at least one storage medium capable of storing methods, programs, code and/or instructions. A central repository may provide program instructions to be executed on different devices. In this implementation, the remote repository may act as a storage medium for program code, instructions, and programs.

The software program may be associated with a client that may include a file client, print client, domain client, internet client, intranet client and other variants such as secondary client, host client, distributed client and the like. The client may include one or more of memories, processors, computer readable media, storage media, ports (physical and virtual), communication devices, and interfaces capable of accessing other clients, servers, machines, and devices through a wired or a wireless medium, and the like. The methods, programs or codes as described herein and elsewhere may be executed by the client. In addition, other devices required for execution of methods as described in this application may be considered as a part of the infrastructure associated with the client.

The client may provide an interface to other devices including, without limitation, servers, other clients, printers, database servers, print servers, file servers, communication servers, distributed servers and the like. Additionally, this coupling and/or connection may facilitate remote execution of program across the network. The networking of some or all of these devices may facilitate parallel processing of a program or method at one or more location without deviating from the scope of the invention. In addition, any of the devices attached to the client through an interface may include at least one storage medium capable of storing methods, programs, applications, code and/or instructions. A central repository may provide program instructions to be executed on different devices. In this implementation, the remote repository may act as a storage medium for program code, instructions, and programs.

The methods and systems described herein may be deployed in part or in whole through network infrastructures. The network infrastructure may include elements such as computing devices, servers, routers, hubs, firewalls, clients, personal computers, communication devices, routing devices and other active and passive devices, modules and/or components as known in the art. The computing and/or non-computing device(s) associated with the network infrastructure may include, apart from other components, a storage medium such as flash memory, buffer, stack, RAM, ROM and the like. The processes, methods, program codes, instructions described herein and elsewhere may be executed by one or more of the network infrastructural elements.

The methods, program codes, and instructions described herein and elsewhere may be implemented on a cellular network having multiple cells. The cellular network may either be frequency division multiple access (FDMA) network or code division multiple access (CDMA) network. The cellular network may include mobile devices, cell sites, base stations, repeaters, antennas, towers, and the like. The cell network may be a GSM, GPRS, 3G, EVDO, mesh, or other networks types.

The methods, programs codes, and instructions described herein and elsewhere may be implemented on or through mobile devices. The mobile devices may include navigation devices, cell phones, mobile phones, mobile personal digital assistants, laptops, palmtops, netbooks, pagers, electronic books readers, music players and the like. These devices may include, apart from other components, a storage medium such as a flash memory, buffer, RAM, ROM and one or more computing devices. The computing devices associated with mobile devices may be enabled to execute program codes, methods, and instructions stored thereon. Alternatively, the mobile devices may be configured to execute instructions in collaboration with other devices. The mobile devices may communicate with base stations interfaced with servers and configured to execute program codes. The mobile devices may communicate on a peer to peer network, mesh network, or other communications network. The program code may be stored on the storage medium associated with the server and executed by a computing device embedded within the server. The base station may include a computing device and a storage medium. The storage device may store program codes and instructions executed by the computing devices associated with the base station.

The computer software, program codes, and/or instructions may be stored and/or accessed on machine readable media that may include: computer components, devices, and recording media that retain digital data used for computing for some interval of time; semiconductor storage known as random access memory (RAM); mass storage typically for more permanent storage, such as optical discs, forms of magnetic storage like hard disks, tapes, drums, cards and other types; processor registers, cache memory, volatile memory, non-volatile memory; optical storage such as CD, DVD; removable media such as flash memory (e.g. USB sticks or keys), floppy disks, magnetic tape, paper tape, punch cards, standalone RAM disks, Zip drives, removable mass storage, off-line, and the like; other computer memory such as dynamic memory, static memory, read/write storage, mutable storage, read only, random access, sequential access, location addressable, file addressable, content addressable, network attached storage, storage area network, bar codes, magnetic ink, and the like.

The methods and systems described herein may transform physical and/or or intangible items from one state to another. The methods and systems described herein may also transform data representing physical and/or intangible items from one state to another.

The elements described and depicted herein, including in flow charts and block diagrams throughout the figures, imply logical boundaries between the elements. However, according to software or hardware engineering practices, the depicted elements and the functions thereof may be implemented on machines through computer executable media having a processor capable of executing program instructions stored thereon as a monolithic software structure, as standalone software modules, or as modules that employ external routines, code, services, and so forth, or any combination of these, and all such implementations may be within the scope of the present disclosure. Examples of such machines may include, but may not be limited to, personal digital assistants, laptops, personal computers, mobile phones, other handheld computing devices, medical equipment, wired or wireless communication devices, transducers, chips, calculators, satellites, tablet PCs, electronic books, gadgets, electronic devices, devices having artificial intelligence, computing devices, networking equipments, servers, routers and the like. Furthermore, the elements depicted in the flow chart and block diagrams or any other logical component may be implemented on a machine capable of executing program instructions. Thus, while the foregoing drawings and descriptions set forth functional aspects of the disclosed systems, no particular arrangement of software for implementing these functional aspects should be inferred from these descriptions unless explicitly stated or otherwise clear from the context. Similarly, it will be appreciated that the various steps identified and described above may be varied, and that the order of steps may be adapted to particular applications of the techniques disclosed herein. All such variations and modifications are intended to fall within the scope of this disclosure. As such, the depiction and/or description of an order for various steps should not be understood to require a particular order of execution for those steps, unless required by a particular application, or explicitly stated or otherwise clear from the context.

The methods and/or processes described above, and steps thereof, may be realized in hardware, software or any combination of hardware and software suitable for a particular application. The hardware may include a general purpose computer and/or dedicated computing device or specific computing device or particular aspect or component of a specific computing device. The processes may be realized in one or more microprocessors, microcontrollers, embedded microcontrollers, programmable digital signal processors or other programmable device, along with internal and/or external memory. The processes may also, or instead, be embodied in an application specific integrated circuit, a programmable gate array, programmable array logic, or any other device or combination of devices that may be configured to process electronic signals. It will further be appreciated that one or more of the processes may be realized as a computer executable code capable of being executed on a machine readable medium.

The computer executable code may be created using a structured programming language such as C, an object oriented programming language such as C++, or any other high-level or low-level programming language (including assembly languages, hardware description languages, and database programming languages and technologies) that may be stored, compiled or interpreted to run on one of the above devices, as well as heterogeneous combinations of processors, processor architectures, or combinations of different hardware and software, or any other machine capable of executing program instructions.

Thus, in one aspect, each method described above and combinations thereof may be embodied in computer executable code that, when executing on one or more computing devices, performs the steps thereof. In another aspect, the methods may be embodied in systems that perform the steps thereof, and may be distributed across devices in a number of ways, or all of the functionality may be integrated into a dedicated, standalone device or other hardware. In another aspect, the means for performing the steps associated with the processes described above may include any of the hardware and/or software described above. All such permutations and combinations are intended to fall within the scope of the present disclosure.

While the invention has been disclosed in connection with the preferred embodiments shown and described in detail, various modifications and improvements thereon will become readily apparent to those skilled in the art. Accordingly, the spirit and scope of the present invention is not to be limited by the foregoing examples, but is to be understood in the broadest sense allowable by law.

All documents referenced herein are hereby incorporated by reference.

What is claimed is:

1. A method for maintaining a social network, the method comprising:
registering users in the social network, wherein registering users comprises storing in association with a user ID for each registered user at least one image; and
verifying the user during a subsequent login by comparing a current image with the stored image; and
restricting user interactions within the social networking system, wherein restrictions are set by a third party.

2. The method of claim 1, wherein the user ID does not contain personally identifying data.

3. The method of claim 1, further comprising: providing a new image if the current image is different from the stored image.

4. The method of claim 1, wherein the restriction is based on an age range of the users.

5. The method of claim 1, wherein the restriction is based on a location of the users.

6. The method of claim 1, wherein the restriction is based on a grade of the users.

7. The method of claim 1, wherein the restriction is based on at least one of a school or school district of the users.

8. The method of claim 1, wherein the restriction is based on the results of a test.

9. The method of claim 1, wherein the restriction is based on an amount of time allowed for interaction with users.

10. The method of claim 1, wherein the restriction is based on gender.

11. The method of claim 1, wherein the third party comprises at least one of a parent, a guardian, a teacher, a mentor, an administrator, and a moderator.

12. A social networking system, comprising:
a networked computer for presenting the social networking system to a user; and
a camera connected to the networked computer for enabling the user to access the social networking system, wherein access requires verification of the user by comparing a current image captured by the camera to a stored image,
wherein restrictions on user interactions within the social networking system are set by a third party.

13. The system of claim 12, wherein the restriction is based on an age range of the users.

14. The system of claim 12, wherein the third party comprises at least one of a parent, a guardian, a teacher, a mentor, an administrator, and a moderator.

15. A method for enabling an interaction in a social network, the method comprising:
setting at least one rule for forming a peer group;
receiving a request for a user to interact with another user;
enabling the user to interact with the other user if both users satisfy the rules for forming a peer group; and
blocking the user from interacting with the other user if the rules for forming a peer group are not satisfied.

16. The method of claim 15, wherein the rule is determined by at least one of a parent, a teacher, a guardian, a mentor, an administrator, a moderator, and a website host.

17. The method of claim 15, wherein the user interaction is blocked temporarily.

18. The method of claim 15, wherein the rule relates to an age difference between the users.

19. A method for moderating wall posts in a social network, the method comprising:
blocking a wall post from public view on a user's wall until being approved by the user; and
at least one of publicly publishing the wall post if approved by the user, continued blocking from public view if not approved, and initiation of an investigation if the wall post is reported by the user.

20. The method of claim 19, wherein moderating wall posts requires approval from a moderator.

21. The method of claim 19, wherein the moderator can reverse the approval.
